(19) United States
(12) Patent Application Publication
(10) Pub. No.: US 2003/0140264 A1
(43) Pub. Date: Jul. 24, 2003

(54) Control method, program and computer apparatus for reducing power consumption and heat generation by a CPU during wait

(75) Inventors: Seiichi Kawano, Sagamihara-shi (JP); Hirohide Komiyama, Zama-shi (JP); Shinji Matsushima, Yokohama-shi (JP); Noritoshi Yoshiyama, Yokohama-shi (JP)

Correspondence Address: IBM Corporation, Intellectual Property Law Dept. 9CCA/B002, P.O. Box 12195, Res. Tri. Park, NC, 27709, US

(73) Assignee: International Business Machines Corporation, Armonk, NY

(21) Appl. No.: 10/328,808

(22) Filed: Dec. 24, 2002

(30) Foreign Application Priority Data
Dec. 26, 2001 (JP) 2001-393336

(51) Int. Cl. G06F 1/08

(52) U.S. Cl. 713/500

(57) ABSTRACT

The present invention lowers the performance, and therefore power consumption, of a Central Processing Unit (CPU) to reduce the power consumption when the CPU encounters waiting time due to certain device-related conditions or in the course of execution of a program, thereby reducing power consumption and heat generation in an entire system. Instruction codes to be executed by a CPU and information about a performance for executing the instruction codes are loaded in the CPU and the performance of the CPU is dynamically set at a value determined based on the information about the loaded information about the performance. Thus, the CPU executes the instruction codes at the set performance.

### BACKGROUND OF THE INVENTION

1. Field of the Invention

The present invention relates to technology for controlling power consumption in a computer system through power management of its CPU (Central Processing Unit), and more particularly to reducing power consumption of and heat generation by a CPU during wait periods.

2. Description of Related Art

In recent years, the performance of CPUs has increased and along with this increase, power consumption of and heat generation by CPUs in computer apparatuses have increased. Often, however, while the system of a computer is busy, power consumption in the CPU makes up a large proportion of the total power consumption in the entire system. Because processing speeds of other devices in the computer apparatus are typically slower than that of the CPU, some amount of CPU wait time may result. For a large portion of the wait time, the CPU performs a useless process. Therefore, there is a need for reducing power consumption and heat generation in the entire apparatus by performing CPU power management during wait time.

The following methods are presently known to be used for reducing power consumption by CPU power management:

(1) method 1 in which power consumption of a CPU per unit time is reduced by lowering the performance of the CPU, and

(2) method 2 in which power consumption of a CPU is reduced by placing the CPU in a power-saving state according to the extent to which CPU processing is required.

Method 1 has been implemented by the use of a Throttling and Speed Step from Intel Corporation. However, the implementation of this step lowers the throughput of system, which is not preferred. In method 2, control is provided depending on requests to the CPU and therefore power consumption of the CPU can be reduced without lowering the performance of the entire system.

Method 2 may typically be used when:

(i) no requests for CPU processing are issued by a CPU scheduler, or

(ii) a CPU has to wait certain amount of time before it receives a response from a device during an I/O (Input-Output) bound task.

Means for placing a CPU in a power-saving state when there are no requests to the CPU in the CPU scheduler can be used to place the CPU in the power-saving state by the CPU scheduler of an OS (Operating System) until the next request is issued to the CPU. Any power-saving states of the four operating states, C0 to C3, specified in ACPI (Advanced Configuration and Power Interface) may be used as the energy-saving state. Alternatively, APM Idle or Int16 may be used to place the CPU in power-saving mode. When snooping of cache memory in the CPU is required, the CPU may be placed back from a power-saving mode (C3) to its normal state (CO) or power-saving states (C1 or C2) in which snooping can be performed. When cache memory snooping is not required, the CPU may simply be kept in a power-saving state until the next request to the CPU is provided.

There have been no practical means for placing a CPU in a power-saving mode while it is waiting for a response from a device in an I/O-bound task. Examples of prior-art methods made available for this purpose include techniques disclosed in U.S. Pat. Nos. 5,875,120 and 5,875,348.

U.S. Pat. No. 5,875,120 discloses a method in which time at which a CPU should be returned from a power-saving state is specified when the CPU is placed in the power-saving state.

U.S. Pat. No. 5,875,348 discloses a method in which the performance of a CPU is lowered to reduce power consumption of the CPU to a level at which the CPU can detects an I/O access such as in Port 61 and yet does not miss a refresh bit.

As described above, a number of methods have been proposed for reducing power consumption in an entire computer system through CPU power management. Of the methods described above, method 2 used for reducing the power consumption of the CPU when (ii) a CPU must wait for a response from a device in an I/O-bound task would also be able to be used for placing the CPU in a power-saving state if the method (i) for reducing the power consumption of the CPU according to the operating status of the CPU does not work (during useless execution while the CPU is waiting for a response from a device).

However, no practical means is available with respect to the method described above and the prior art described above has problems as further described below.

The following methods are commonly used when the CPU must wait a certain amount of time until a response is returned from a device in an I/O-bound task.

A method in which a memory refresh timer (15.2 msec) is counted while waiting the certain amount of time under the control of BIOS (Basic Input/Output System).

A method in which the performance of the CPU is measured by an OS or a device driver beforehand and a CPU loop instruction is used while waiting a certain amount of time. This method, which is based on the performance of the CPU, does not require special hardware but accurate wait time cannot always be calculated.

A method in which an ACPI timer is used to wait a certain amount of time in controlling a device driver under an OS.

The technique disclosed in U.S. Pat. No. 5,875,120 involves making changes to the BIOS, OS, or device driver so as to specify time at which the BIOS, OS, or device driver returns from a power-saving state. Therefore, this technique is difficult to introduce.

The method disclosed in U.S. Pat. No. 5,875,348 may lower the performance of a CPU even when it is not required to be lowered. Therefore, this method may decrease system throughput.

The method for lowering the performance of a CPU (method 1 described above) typically lowers system throughput, as described above. However, this method does not significantly lower the throughput for tasks such as those in game software, which contains many idle loops. If such tasks can be identified to lower the performance of the CPU, the power consumption can be reduced accordingly.

Therefore, an object of the present invention is to provide practical means for lowering the performance, and therefore power consumption, of a CPU to reduce its power consumption when the CPU encounters waiting time due to certain device-related conditions or in the course of execution of a program, thereby reducing power consumption and heat generation in an entire system.

### SUMMARY OF THE INVENTION

Accordingly, there is a need for an apparatus, method and program that overcomes the problems discussed above.

In one aspect, the present invention that achieves the object can be implemented as a CPU control method for controlling a CPU performance. The control method comprises steps of: loading into said CPU instruction codes to be executed by said CPU and information about said performance for executing said instruction codes; setting the performance of said CPU at a value determined based on said information about the performance; and executing said instruction codes by said CPU at said set performance.

Preferably, the CPU control method further comprises the step of generating correlation information for correlating a memory region in a memory with the information about the performance of the CPU for executing instruction codes loaded in the memory region. The step of loading the information about the performance into the CPU comprises the steps of: reading instruction codes to be executed from the memory; and obtaining information about a performance for executing the instruction codes from the correlation information about the memory region in which the read instruction codes are loaded.

Alternatively, in the CPU control method, the step of loading into the CPU the information about the performance into the CPU may comprises the step of reading a performance specifying instruction specifying the performance of the CPU for executing a predetermined instruction sequence written in a program containing the instruction codes.

In another aspect, the present invention can be implemented as a CPU control method as described below. The CPU control method comprises the steps of: setting in a memory a plurality of memory regions correlated with different performances of the CPU; and, when instruction codes to be executed is read from the memory, causing the CPU to operate, at a performance correlated with the memory region in which the instruction codes are loaded to execute the instruction codes.

More specifically the step of setting the memory regions in said memory comprises the step of creating a page table containing information about the performance of the CPU for each page, said page being provided by separating the memory space of said memory.

In another aspect, the present invention that achieves the above-described object can also be implemented as a computer apparatus configured as described below. The computer apparatus comprises a CPU (Central Processing Unit) for reading and executing instruction codes written in a program; and clock controller for controlling the operating clock of the CPU, wherein, when executing given instruction codes, the CPU directs the clock controller to dynamically change the operating clock based on information about a performance that is set for the instruction codes.

The clock controller may be a clock generator for providing an operating clock to the CPU and a controller controlling the clock generator.

The computer apparatus may further comprise memory in which a plurality of memory regions correlated with different performances of the CPU are set. The CPU obtains information about the performance to issue a direction to the clock controller based on a memory region out of the memory regions in which instruction codes read from the memory have been loaded.

Preferably, the computer apparatus further comprises a memory managing module for managing memory space on a page basis and specifying a performance of the CPU on a page basis to correlate the performance with the memory region. The memory managing module may be a page directory or a page table.

In another aspect, the CPU of the computer apparatus may read a performance specifying instruction written in the program that specifies the performance of the CPU for executing a given instruction sequence and issue the direction to the clock controller in accordance with the performance specifying instruction.

In another aspect, the present invention can also be implemented as a computer apparatus configured as described below. The computer apparatus comprises a CPU for reading a program to perform computation and inputting data from and outputting data to an external device; and a clock controller for controlling the operating clock of the CPU, wherein, the CPU direct the clock controller to dynamically change the operating clock when performing an I/O-bound process. Alternatively, the CPU directs the clock controller to dynamically change the operating clock when performing an idle loop process to wait for an input.

In another aspect, the present invention that achieves the object described earlier can also be implemented as a CPU configured as described below and capable of controlling a clock generator to dynamically change an operating clock. The CPU comprises an instruction reading module for reading instruction codes from memory; an information obtaining module for obtaining information about a performance that is set for the read instruction codes; and a directing module for issuing a direction to a controller of the clock generator to change the operating clock based on the obtained information about the performance. The CPU operates in accordance with the operating clock dynamically controlled by the direction for changing the operating clock issued to the controller.

In particular, the information obtaining module obtains, based on a memory region in which the read instruction codes are loaded, the information about the performance that is correlated with the memory region to issue the direction to the controller. Preferably, the information obtaining module obtains the information about the performance of the CPU on a page basis based on memory management information for managing memory space on a page basis.

Alternatively, when the instruction reading module reads instruction codes that specifies the performance of the CPU for executing a given instruction sequence, the information obtaining module identifies the instruction codes as the information about the performance.

In another aspect, the present invention can also implemented as a program for controlling a computer as described below. The program causes the computer to implement the function of: setting a plurality of memory regions correlated with different performances of a CPU (Central Processing Unit) in a memory; and loading instruction codes in a program into one of the memory regions that corresponds to a desired one of the performances of the CPU for executing said instruction codes.

Alternatively, the present invention can also be implemented as a program as described below. The program causes a computer to operate as:

processing module for causing a given computation process to be executed; and an operation control module for causing the performance of the processing module to be dynamically changed when the processing module executes an instruction sequence specified in instruction codes in the program.

These programs may be stored in a magnetic disk, optical disk, semiconductor memory, or other storage media and delivered to users or may be distributed over a network to users.

### BRIEF DESCRIPTION OF THE DRAWINGS

Other aspects, features, and advantages of the present invention will become more fully apparent from the following detailed description, the appended claims, and the accompanying drawings in which:

FIG. 1 schematically shows an example of hardware configuration of a computer apparatus performing power management for a CPU according to a preferred embodiment of the present invention;

FIG. 2 shows a system configuration for performing power management for the CPU by using the computer apparatus shown in FIG. 1 and method 1;

FIG. 3 shows exemplary page table entry descriptions according to a preferred embodiment of the present invention;

FIG. 4 shows the relationship between descriptions in the page table entry shown in FIG. 3 and performances of the CPU;

FIG. 5 shows an example of a memory map in which performances specified in page table entries are reflected according to a preferred embodiment of the present invention;

FIG. 6 shows a flowchart of a process for loading an operating system in memory according to a preferred embodiment of the present invention;

FIG. 7 shows a flowchart of a process for accepting a CPU performance set by a user according to a preferred embodiment of the present invention;

FIG. 8 shows a flowchart of a process performed for activating and executing an application program according to a preferred embodiment of the present invention;

FIG. 9 shows a flowchart of a process performed by the CPU when executing the application program in FIG. 8;

FIG. 10 schematically shows memory mapping in which an I/O-bound task is read into a low-performance region according to the first embodiment;

FIG. 11 schematically shows memory mapping in which an idle loop process is read into a performance region according to a preferred embodiment of the present invention;

FIG. 12 shows a system configuration for performing power management by using the computer apparatus shown in FIG. 1 and method 2;

FIG. 13 shows the relationship between performance specifying instructions written in a program and CPU performances according to a preferred embodiment of the present invention; and,

FIG. 14 shows an operation performed by a CPU when it reads an instruction sequence according to a preferred embodiment of the present invention.

### DETAILED DESCRIPTION

The use of figure reference labels in the claims is intended to identify one or more possible embodiments of the claimed subject matter in order to facilitate the interpretation of the claims. Such labeling is not to be construed as necessarily limiting the scope of those claims to the embodiments shown in the corresponding figures. The preferred embodiments of the present invention and its advantages are best understood by referring to the drawings, like numerals being used for like and corresponding parts of the various drawings. The present invention will be described with respect to embodiments shown in the accompanying drawings.

An overview of the present invention will be described first. Some CPUs commercially available today are externally controllable in their performance. Example of such CPUs include Crusoe from Transmeta Corporation in the U.S.A. and PentiumÒ from Intel Corporation in the U.S.A. Power management of such a CPU is achieved by dynamically changing the performance of the CPU in response to a change in utilization of the CPU under control of an OS or application.

The present invention provides semantics in an instruction set in an appropriate architecture to a CPU as a condition for changing its performance to provide power management of the CPU. The present invention proposes the following two methods for this purpose.

Method 1—specifies an instruction set region that is loaded in memory and CPU performance required for the instruction set region.

Method 2—specifies a given instruction sequence and CPU performance required for the instruction.

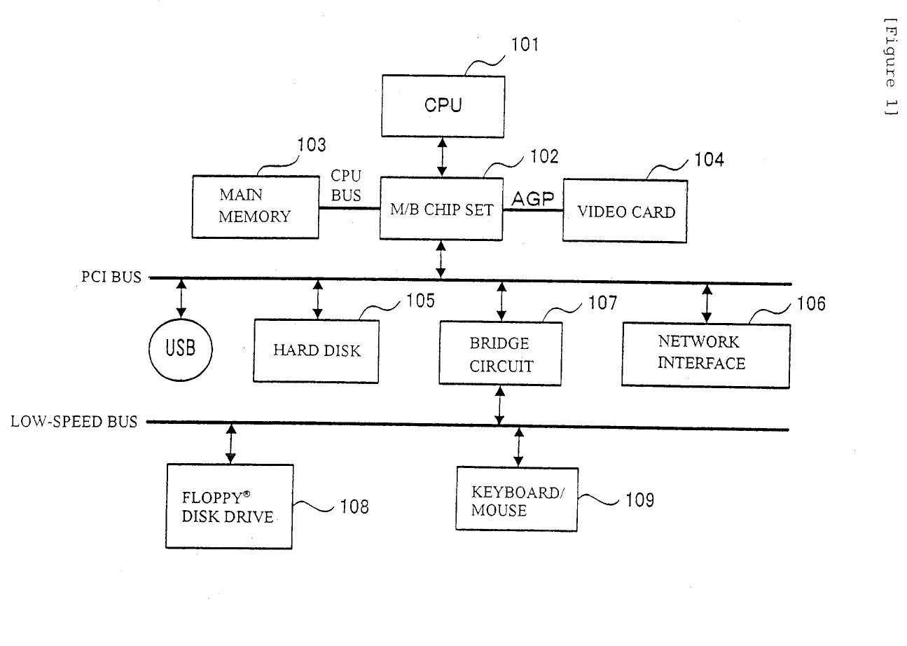

FIG. 1 schematically shows an example of a hardware configuration of a computer apparatus performing power management of a CPU according to a first embodiment, which corresponds to method 1.

The computer apparatus shown in FIG. 1 comprises a CPU (Central Processing Unit) 101, which is computing means, a main memory 103 connected to the CPU 101 through an M/B (mother board) chip set 102 and a CPU bus, a video card 104 connected to the CPU 101 through the M/B chip set 102 and an AGP (Accelerated Graphics Port), a hard disk 105 and a network interface 106 connected to the M/B chip set 102 over a PCI (Peripheral Component Interconnect) bus, and floppy^{Ò} disk drive 108 and a keyboard/mouse 109 connected to the M/B chip set 102 through a bridge circuit 107, a low-speed bus such as an ISA (Industry Standard Architecture) bus, and the PCI bus. The computer apparatus further comprises a clock generator and its controller (not shown in FIG. 1) for controlling the performance (operating clock) of the CPU 101 as will be described later.

FIG. 1 shows just an example of the hardware con figuration of the computer apparatus that implements the present embodiment. Various other configurations may be used to which the present embodiment can be applied. For example, a discrete video memory may be provided instead of the video card 104 and the CPU 101 may process image data. In addition, a sound facility may be provided for inputting and outputting sound data or a CD-ROM (Compact Disc Read Only Memory) and DVD-ROM (Digital Versatile Disk Read Only Memory) drives may be provided through an interface such as an ATA (AT Attachment).

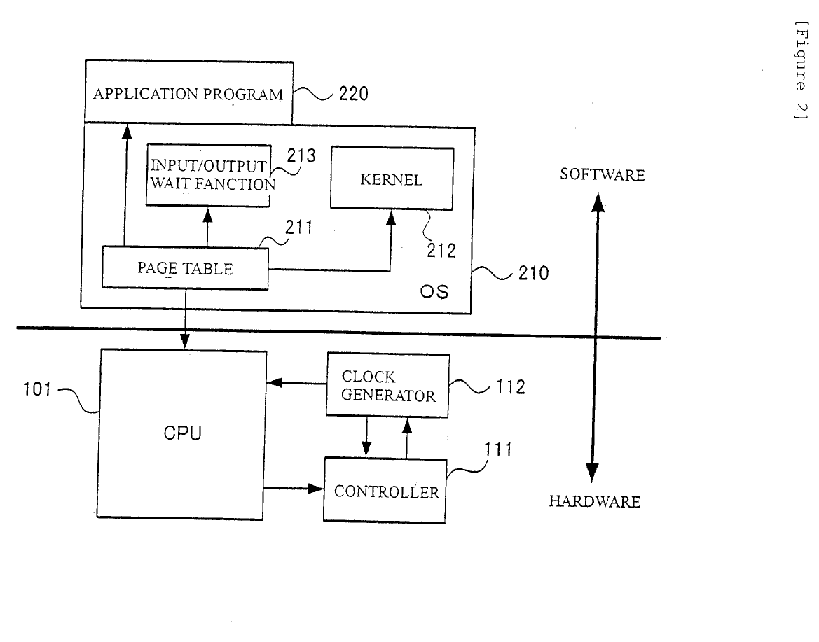

FIG. 2 shows a system configuration of the computer apparatus shown in FIG. 1 for using method 1 described above to perform power management of the CPU.

In FIG. 2, an OS 210 and an application program 220, which are software, are stored in the hard disk 105 shown in FIG. 1 and read into the main memory 103 to control the operation of the CPU 101. The computer apparatus comprises a clock generator 112 and its controller 111 as means for controlling the performance of the CPU 101.

In the present embodiment, the performance of the CPU 101 is specified in accordance with a region in the main memory 103 into which instruction codes of the OS 210 or the application program 220 are loaded. The CPU 101 then indicates to the controller 111 the specified value for the performance, which is identified in the memory region in which the instruction codes are loaded to cause it to control the clock generator 112, thereby providing the specified performance.

As shown, the OS 210 comprises a page table 211, a kernel function 212, and I/O wait function 213. The kernel function 212 is a virtual software block that controls the CPU 101 to provide basic control functions. The I/O wait function 213 is a virtual software block that controls the CPU 101 to provide control functions in a wait state during input or output of a signal.

The page table 211 is memory management means for managing memory by mapping between physical addresses and logical addresses by using paging. In the present embodiment, performance attributes are added to entries in the page table 211 and the CPU 101 operates at a performance level specified in the page table entry for each page to implement power management.

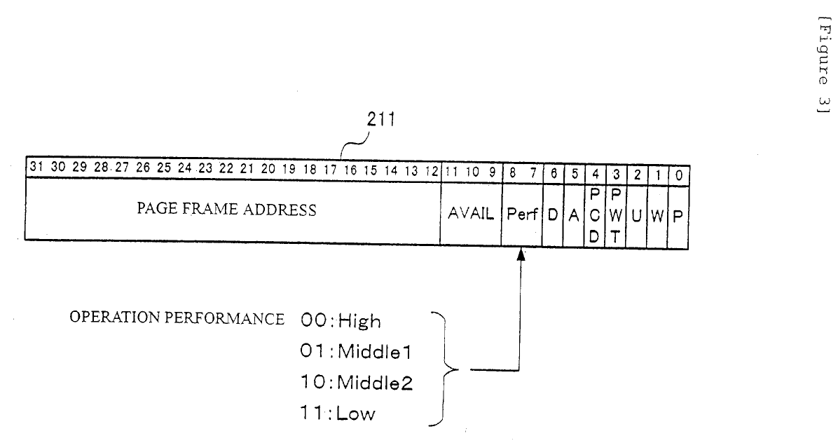

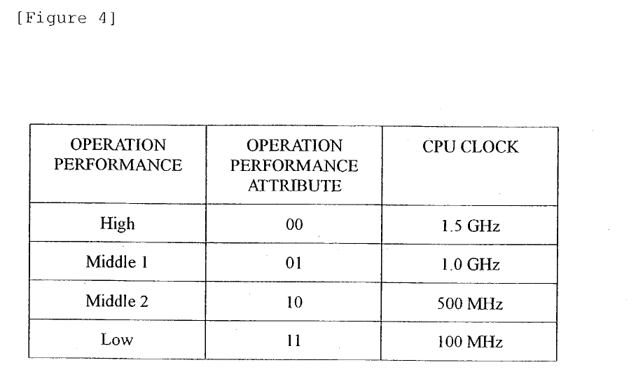

FIG. 3 shows an example of page table entry description. FIG. 4 shows the relationship between performance attribute descriptions in the page table entry in FIG. 3 and performances of the CPU 101.

Referring to FIG. 3, four performances, “00:High”, “01:Middle1”, “10:Middle2”, “11:Low”, are set and written using 2-bit data. Referring to FIG. 4, when the performance attribute description in the page table entry is “00:High”, the operating speed of the CPU 101 (CPU clock) is 1.5 GHz. Similarly, when the performance attribute description is “01:Middle1”, the CPU clock is 1.0 GHz. When the performance description is “10:Middle2”, the CPU clock is 500 MHz. When the performance attribute description is “11:Low”, the CPU clock is 100 MHz.

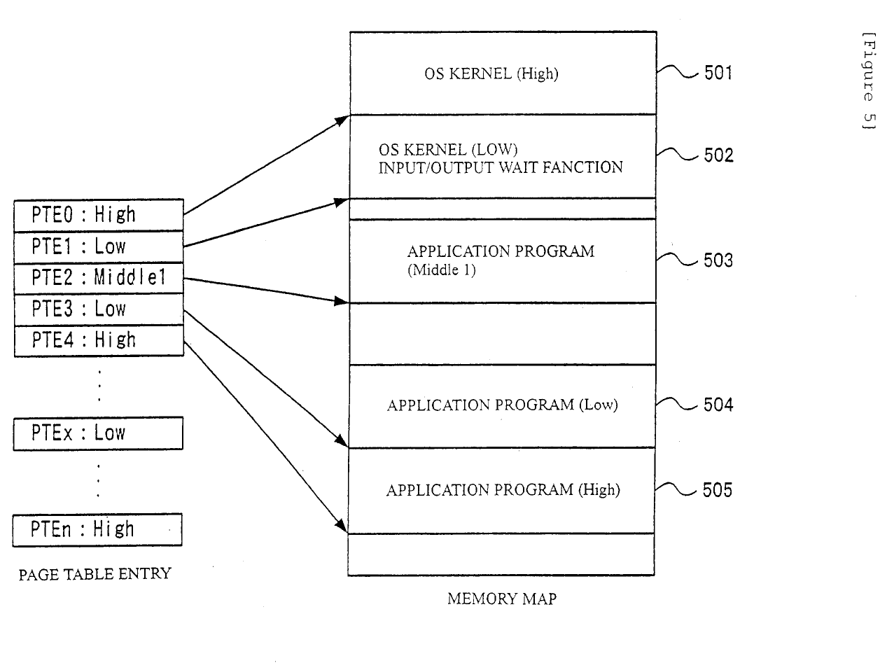

Alternatively, a page directory (not shown), which is used for paging memory management together with the page table 211, may be used and performance attributes may be added to page directory entries instead of the page table entries to achieve similar power management. FIG. 5 shows an exemplary memory map in which performances specified in the page table entries are reflected.

Referring to FIG. 5, high performance is specified in page table entry (PTE) 0 (High in FIG. 3), low performance is specified in page table entry 1 (Low in FIG. 3) middle performance 1 is specified in page table entry 2 (Middle1 in FIG. 3), middle performance is specified in page table entry 3, and high performance is specified in page table entry 4. Referring to the memory map, memory regions 501 and 502 corresponding to page table entries 0 and 1 are used by the OS 210 and memory regions 503, 504, and 505 corresponding to page table entries 2, 3, and 4 are used by the application program 220.

The CPU 101 in the present embodiment can read a performance attribute in one of the page table entries described above and direct the controller 111 according to the attribute value to change the clock frequency of the clock generator 112. Thus, when the CPU 101 reads instruction codes to execute from one of the predetermined memory regions 501 through 505 in the main memory 103, the CPU 101 identifies the memory region from among the memory regions 501 through 505 in which the instruction codes are loaded, and references one of the page table entries 0 through n that corresponds to that memory region 501 through 505 to obtain a performance attribute, which is information about a performance level at which the CPU 101 execute the instruction codes. The CPU 101 indicates the attribute value to the controller 111 to cause it to change the clock frequency of the clock generator 112 as appropriate, thereby operating at the specified operating clock to execute the instruction codes.

Low-performance memory region 502 is assigned to the input/output wait function 213 in the OS 210 that does not need high-speed processing. Thus, the CPU 101 according to the present embodiment executes the input/output function 213 at a low-speed performance level of 100 MHz. Likewise, each instruction code of the kernel 212 of the OS 210 and the application program 220 is allocated to a predetermined location in the memory regions 501 through 505 according to the performance of the CPU 101 required by a function provided.

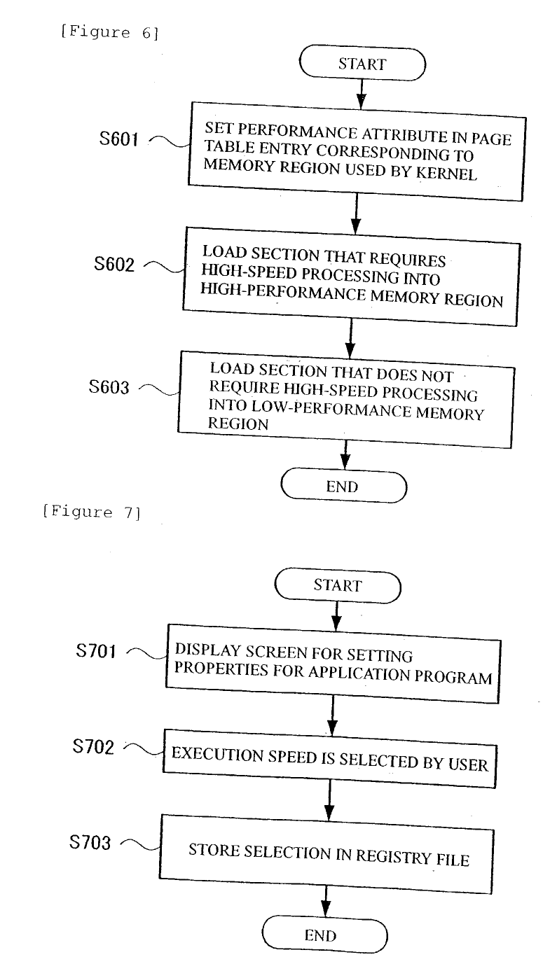

FIG. 6 shows a flowchart of a process for loading the OS 210 in the main memory 103 according to the present embodiment.

First, a performance attributes are set in page table entries (PET0 and PET1 in the example in FIG. 5) corresponding to memory regions (the memory regions 501 and 502 in FIG. 5, for example) used by the kernel 212 of the OS 210 (step 601). Then, a section in the kernel 212 that requires high-speed processing is loaded in a high-performance memory region (memory region 501 in the example in FIG. 5) (step 602) and a section that does not require high-speed processing is loaded in a low-performance memory region (memory region 502 in the example in FIG. 5) (step 603).

In this way, an appropriate performance of the CPU 101 is specified for each function of the OS 210. The CPU 101 will execute each function at the specified performance level. Which section of the OS 210 should be executed at which performance level may be specified during designing the OS 210, for example and each section may be loaded according to the setting during the startup of the OS 210.

The performance of the CPU 101 for executing an application program 220 may be specified by a user.

FIG. 7 shows a flowchart of a process for accepting a performance of the CPU 101 set by a user.

Referring to FIG. 7, first a screen for setting properties for the application program 220 is displayed on a display device to wait for the entry of an execution speed selection (step 701).

If Windows^{Ò} from Microsoft corporation is used as the OS 210, the property setting screen may be a user interface which can be displayed by selecting a property item from an menu displayed by a right-click of a mouse.

Then, the user performs an operation for selecting an execution speed (step 702) and the selection is stored in a registry file (step 703).

In this way, the performance of the CPU 101 for performing the application program 220 is set. When the application program 220 is read into the main memory 103, an appropriate memory region is allocated to it.

An operation of the CPU 101 when executing the application program 220 will be described below.

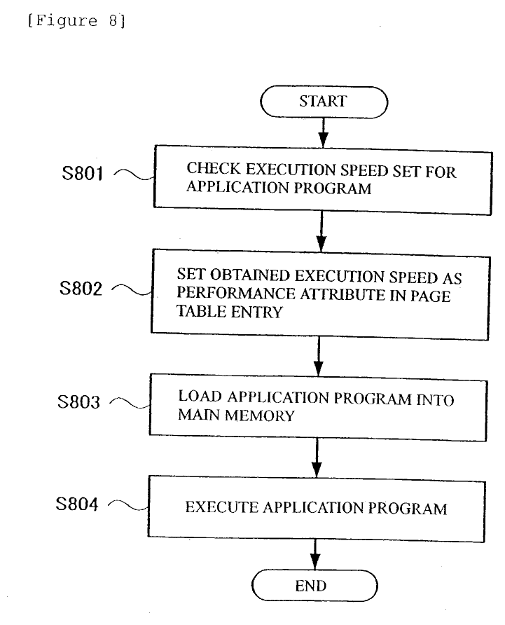

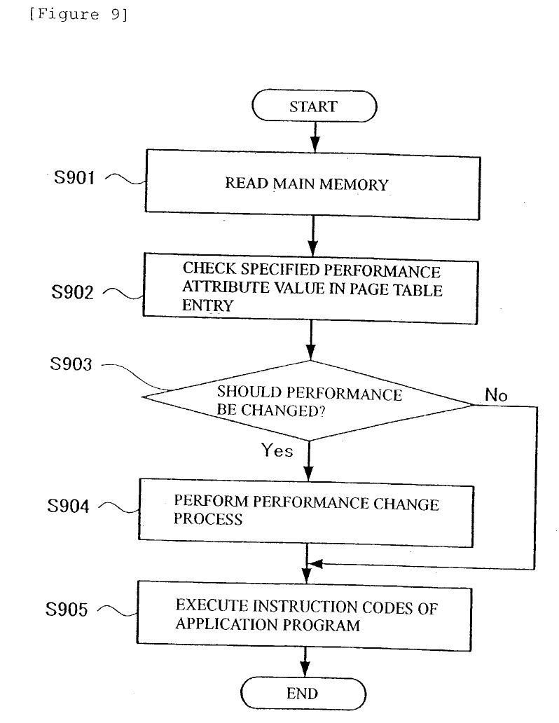

FIG. 8 shows a flowchart of a process for activating and executing the application program 220. FIG. 9 shows a flowchart of a process performed by the CPU 101 when executing the application program 220.

Referring to FIG. 8, the execution speed set for the application program 220 performed by the operation shown in FIG. 7 is checked in response to the input of an instruction for starting up the application program 220 (step 801). Then, the execution speed obtained through the check is set as the performance attribute in an appropriate page table entry in the page table 211 of the OS 210 (step 802).

Then, the application program 220 is loaded into the main memory 103 (step 803) and executed by the CPU 101 (step 804).

The application program 220 is executed by the CPU 101 at step 804 as follows.

Referring to FIG. 9, the CPU 101 reads the main memory 103 (step 901) and checks a specified performance attribute value in an appropriate page table entry in the page table 211 of the OS 210 (step 902). If the performance does not require to be changed, the CPU 101 simply executes instruction codes of the application program 220 (steps 903 and 905).

On the other hand, if the performance should be changed, the CPU 101 indicates the specified performance value to the controller 111 to cause it to perform a performance change process for changing the clock rate of the clock generator 112 (steps 903 and 904), then executes the instruction codes of the application program 220 (step 905).

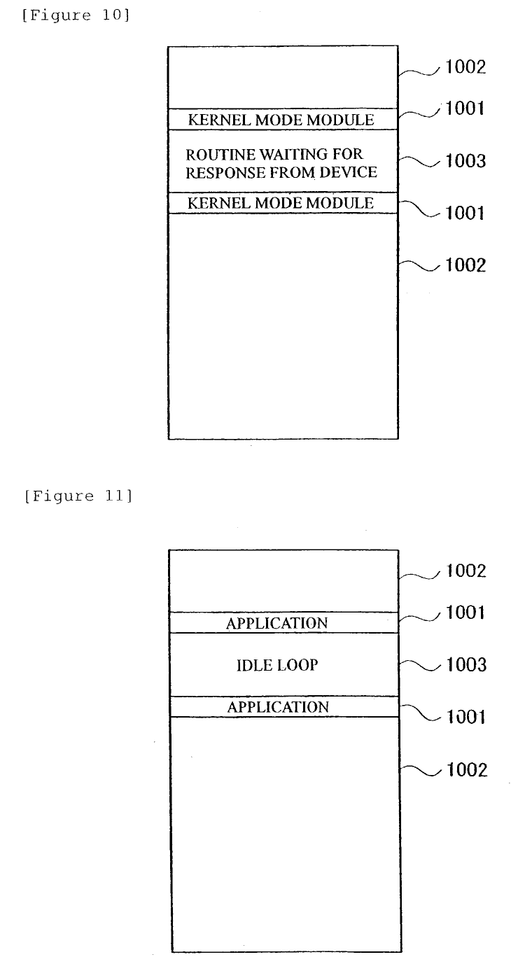

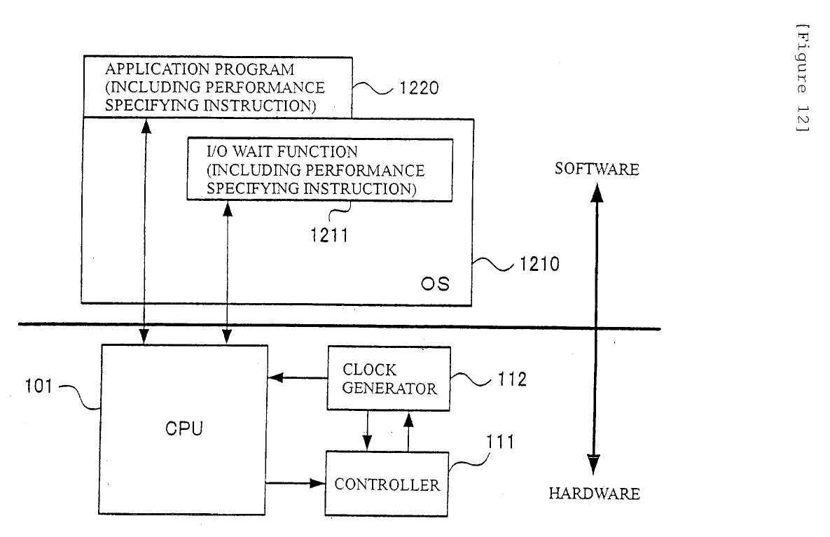

FIGS. 10 and 11 schematically show memory mapping according to the present embodiment.

As shown in FIG. 10, set in a memory map are high-performance region 1001 for causing the CPU to operate at a high speed, a normal-performance region 1002 causing it to operate at a medium speed, and a low-performance region 1003 for causing it to operate at a low speed. A section that requires high-speed processing uses the high-performance region 1001 and a section that does not require high-speed processing uses the normal-performance region 1002 or low-performance region 1003. In the example shown, a kernel mode module uses the high-performance region 1001 and a routine (I/O bound task) that waits for a response from a device for a fixed short period of time uses the low-performance region 1003.

As shown in FIG. 11, a given application program may be set to use the high-performance region 1001 to achieve high-speed processing and use the low-performance region 1003 for an idle loop process that waits for an input to lower the processing speed.

Power management of a CPU according to a second embodiment, which corresponds method 2 described earlier, will be described below.

Like the predetermined first embodiment, the second embodiment is performed by the computer apparatus shown in FIG. 1.

FIG. 12 shows a system configuration of the computer apparatus shown in FIG. 1 for using method 2 described earlier to perform power management of the CPU, in which method a give instruction sequence is specified and the performance of the CPU that is required for that instruction sequence is specified.

In FIG. 12, an OS 1210 and an application program 1220, which are software, are stored in the hard disk 105 shown in FIG. 1 and read into the main memory 103 to control operation of the CPU 101.

According to the present embodiment, instruction codes (hereinafter called a performance specifying instruction) for specifying the performance of the CPU 101 are written in the OS 1210 or the application program 1220. The CPU 101 indicates the specified performance value to the controller 111 based on the performance specifying instruction to cause it to control the clock generator 112 to provide the specified performance.

In the OS 1210, a desired performance specifying instruction is written for a program function to be executed by a changed performance of the CPU 101. In the example shown in FIG. 12, a performance specifying instruction is written for an I/O wait function 1211. A performance specifying instruction can be written for the entire application program 1220 or each of predetermined program functions.

According to the present embodiment, the CPU 101 can read a performance specifying instruction written in any of the above-described programs and direct the controller 111 to cause it to change the clock frequency of the clock generator 112 according to that instruction. Thus, when the CPU 101 reads a performance specifying instruction during execution of a program such as the OS 1210 and application program 1220, it obtains a specified performance value based on that performance specifying instruction. The CPU 101 then indicates that specified value to the controller 111 to cause it to change the clock frequency of the clock generator 112 as require and operates at the specified operating clock to execute the instruction codes.

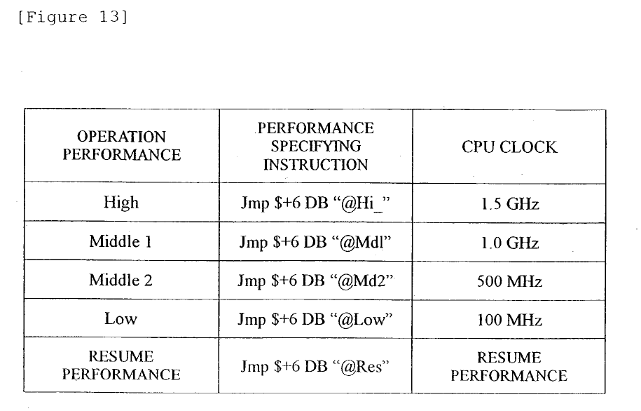

FIG. 13 shows the relationship between performance specifying instructions written in a program and CPU 101 performances.

In the example shown in FIG. 13, four performances, High (1.5 GHz), Middle1 (1.0 GHz), Middle2 (500 MHz), and Low (100 MHz), are set for the CPU 101. In addition, a resume performance is set for retuning to the previous performance.

Performance specifying instructions for these settings are as follows: “Jmp $+6 DB “@Hi_” for High, “Jmp $+6 DB “@Md1” for Middle1, “Jmp $+6 DB “@Md2” for Middle2, “Jmp $+6 DB “@Low” for Low, and “Jmp $+6 DB “@Res” for the resume performance.

Once the CPU 101 reads a performance specifying instruction written in a program as described above, it execute subsequent instructions at a clock or voltage specified by the performance specifying instruction.

An operation of the CPU 101 when executing a program in which a performance specifying instruction is written will be described below.

The assumption is that the following instruction sequence is contained in the program.

Low-performance (Low) instruction: Jmp $+6 DB “@Low”

Program function that does not require high execution speed

Resume-performance instruction: Jmp $+6 DB “@Res”

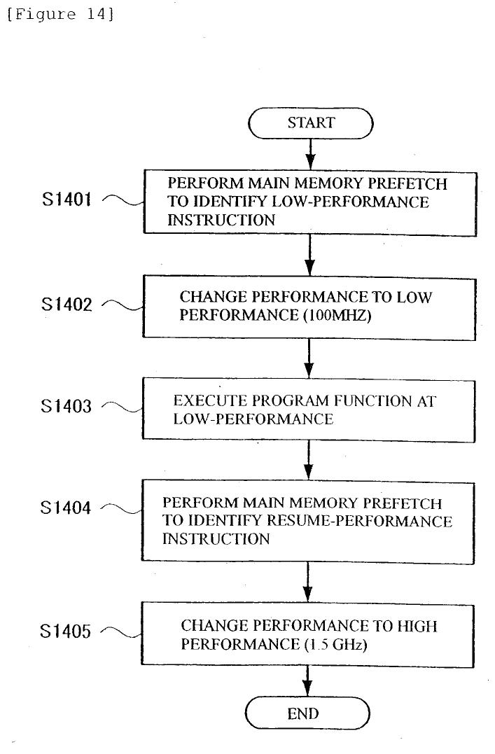

FIG. 14 shows a flowchart of an operation of the CPU when reading the instruction sequence provided above. The CPU 101 initially operates at a high performance Y (High) level of 1.5 GHz.

Referring to FIG. 14, the CPU 101 performs a prefetch of the main memory 103 to find the low-performance instruction (step 1401). Then the CPU 101 direct the controller 111 to control the clock generator 112 to change the performance to a low performance (Low) of 100 MHz (step 1402). The CPU 111 then reads and executes at the changed performance a program function that does not require high execution speed (step 1403).

0

Then, the CPU 101 performs a prefetch of the main memory 103 to find the resume-performance instruction (step 1404). It directs the controller 111 to control the clock generator 112 to return its performance to the previous, high performance (High) of 1.5 GHz (step 1405).

From then on, the CPU 101 reads and executes a program function at higher execution speed of the high performance (High).

According to the present embodiment, power management of the CPU 101 is performed based on an instruction sequence, that is, what type of process is to be performed by the CPU 101, rather than the operating status of the CPU 101, as described above. Consequently, during a condition in which the CPU 101 is not being used, such as an I/O-bound process or idle loop process, the performance of the CPU 101 can be lowered in a fine manner to reduce power consumption and heat generation.

Furthermore, because the function of reducing power consumption during CPU 101 wait time is included in the memory or the CPU itself, changes to device drives are not required. In addition, the performance of the CPU 101 is controlled on an instruction sequence basis of predetermined processes, thereby preventing unnecessary reduction of performance.

The execution speed of CPUs 101 will become faster and faster. Some applications such as image processing can make full use of such high execution speeds. However, many application programs, such as word processors which mainly process text data, do not require such high CPU performance.

Therefore, the control method according to the embodiments described above can be implemented in which the performance of the CPU 101 is normally kept low, instead of significantly lowering the performance of a CPU when it executes predetermined processes and, when the CPU 101 performs processes such as image processing process that requires high performance or application programs such as a computer game that involves many such processes, the performance of the CPU 101 is increased for the individual processes.

It will be further understood that various changes in the details, materials, and arrangements of the parts which have been described and illustrated in order to explain the nature of this invention may be made by those skilled in the art without departing from the principle and scope of the invention as expressed in the following claims.

What is claimed is:

1. A Central Processing Unit (CPU) control method for controlling the performance of a CPU, comprising the steps of:
loading into said CPU instruction codes to be executed by said CPU and information about the performance for executing said instruction codes;
setting the performance of said CPU at a value determined based on said information about the performance; and
executing said instruction codes by said CPU at said set performance.

2. The CPU control method according to claim 1, further comprising the step of generating correlation information for correlating a memory region in a memory with the information about the performance of said CPU for executing instruction codes loaded in said memory region;
wherein said step of loading said information about the performance into the CPU comprises the steps of:
reading instruction codes to be executed from said memory; and
obtaining information about a performance for executing said instruction codes from said correlation information about said memory region in which said read instruction codes are loaded.

3. The CPU control method according to claim 1, wherein said step of loading into said CPU said information about the performance into the CPU comprises the step of reading a performance specifying instruction specifying the performance of said CPU for executing a predetermined instruction sequence written in a program containing said instruction codes.

4. A CPU control method for controlling the performance of a CPU (Central Processing Unit), comprising the steps of:
setting in a memory a plurality of memory regions correlated with different performances of said CPU; and,
when instruction codes to be executed is read from said memory, causing said CPU to operate at a performance correlated with said memory region in which said instruction codes are loaded to execute said instruction codes.

5. The CPU control method according to claim 4, wherein said step of setting the memory regions in said memory comprises the step of creating a page table containing information about the performance of the CPU for each page, said page being provided by separating the memory space of said memory.

6. A computer apparatus comprising:
a Central Processing Unit (CPU) for reading and executing instruction codes written in a program; and
clock controller for controlling the operating clock of said CPU,
wherein, when executing given instruction codes, said CPU directs said clock controller to change the operating clock based on information about a performance that is set for said instruction codes.

7. The computer apparatus according to claim 6, further comprising memory in which a plurality of memory regions correlated with different performances of said CPU are set,
wherein said CPU obtains information about said performance to issue a direction to said clock controller based on a memory region out of said memory regions in which instruction codes read from said memory have been loaded.

8. The computer apparatus according to claim 7, further comprising a memory managing module for managing memory space on a page basis and specifying a performance of said CPU on a page basis to correlate said performance with said memory region.

9. The computer apparatus according to claim 6, wherein said CPU reads a performance specifying instruction written in said program that specifies the performance of said CPU for executing a given instruction sequence and issues the direction to said clock controller in accordance with said performance specifying instruction.

10. A computer apparatus comprising a Central Processing Unit (CPU) for reading a program to perform computation and inputting data from and outputting data to an external device; and
a clock controller for controlling the operating clock of said CPU,
wherein, said CPU direct said clock controller to change the operating clock when performing an I/O-bound process.

11. A computer apparatus comprising:
a Central Processing Unit (CPU) for reading a program to perform computation and inputting data from and outputting data to an external device; and
a clock controller for controlling the operating clock of said CPU;
wherein, said CPU directs said clock controller to change the operating clock when performing an idle loop process to wait for an input.

12. A Central Processing Unit (CPU) capable of controlling a clock generator to change an operating clock, comprising:
an instruction reading module for reading instruction codes from a memory;
an information obtaining module for obtaining information about a performance that is set for said read instruction codes; and
a directing module for issuing a direction to a controller of said clock generator to change the operating clock based on said obtained information about the performance;
wherein said CPU operates in accordance with the operating clock controlled by the direction for changing the operating clock issued to said controller.

13. The CPU according to claim 12, wherein said information obtaining module obtains based on a memory region in which said read instruction codes are loaded the information about said performance that is correlated with said memory region to issue the direction to said controller.

14. The CPU according to claim 13, wherein said information obtaining module obtains the information about the performance of said CPU on a page basis based on memory management information for managing memory space on a page basis.

15. The CPU according to claim 12, wherein, when said instruction reading module reads instruction codes that specifies the performance of said CPU for executing a given instruction sequence, said information obtaining module identifies said instruction codes as the information about said performance.

16. A program for controlling a computer to cause said computer to implement the function of:
setting a plurality of memory regions correlated with different performances of a Central Processing Unit (CPU) in a memory; and
loading instruction codes in a program into one of said memory regions that corresponds to a desired one of said performances of said CPU for executing said instruction codes.

17. A program for controlling a computer to cause said computer to operate as:
processing module for causing a given computation process to be executed; and
an operation control module for causing the performance of said processing module to be changed when said processing module executes an instruction sequence specified in instruction codes in said program.
